(19) United States
(12) Patent Application Publication
(10) Pub. No.: US 2019/0258096 A1
(43) Pub. Date: Aug. 22, 2019

(54) DISPLAY PANEL AND METHOD FOR MANUFACTURING OF DISPLAY PANEL

(71) Applicants: HKC Corporation Limited, Shenzhen (CN); Chongqing HKC Optoelectronics Technology Co., Ltd., Chongqing (CN)

(72) Inventor: CHUNG-KUANG CHIEN, Chongqing (CN)

(21) Appl. No.: 16/345,732

(22) PCT Filed: Apr. 20, 2017
(86) PCT No.: PCT/CN2017/081230

§ 371 Date: Apr. 29, 2019

(30) Foreign Application Priority Data
Dec. 28, 2016 (CN) 201611234025.3

(51) Int. Cl. G02F 1/1333; G02F 1/13

(52) U.S. Cl. CPC G02F 1/1333; G02F 2001/133302; G02F 1/1303

(57) ABSTRACT

This application provides a display panel and a method for manufacturing the display panel. The display panel includes a substrate, a second substrate opposite to the first substrate, and a control circuit fixed on the first substrate or the second substrate by common sealant. Edges of the first substrate and the second substrate are sealed by the common sealant.

This application claims priority to Chinese Patent Application No. CN2016112340253, tiled with the Chinese Patent Office on Dec. 28, 2016 and entitled “DISPLAY PANEL AND METHOD FOR MANUFACTURING OF DISPLAY PANEL”, which is incorporated herein by reference in its entirety.

### TECHNICAL FIELD

This application relates to the field of display technology, and more particularly to a display panel and a method for manufacturing the display panel.

### BACKGROUND

Statement herein merely provides background information related to this application and does not necessarily constitute the existing technology.

Liquid Crystal Display (LCD) apparatuses have more advantages, such as thin body; power saving, no radiation, and the LCD apparatuses are widely used. In an existing market, most of the LCD apparatuses are backlit type LCD apparatuses including a Liquid Crystal Display (LCD) panel and a backlight: module. Operating principle of the LCD panel is that liquid crystal molecules are positioned between two substrates that are parallel to each other, and a driving voltage is applied to two substrates to control orientation of the liquid crystal molecules, further reflecting light of the backlight module and generating images.

As Thin Film Transistor Liquid Crystal Display (TFT-LCD) apparatuses have low power dissipation, good image quality, and high production yield and so on, the TFT-LCD apparatuses have gradually occupied a leading position in the display field. The TFT-LCD apparatuses include the LCD panel and the backlight module, where the LCD panel includes Color Filter (CF) substrate and a Thin Film Transistor (TFT) substrate, and a photomask. A transparency electrode is disposed in opposite side of the above two substrates. Liquid crystal molecules are positioned between the two substrates.

A frameless display apparatus does not have a metal frame or a sealant frame covered on the display panel. Therefore, sides of the display panel are affected by backlight, which results in some light rays reflected by the sides of the display panel to be observed by human eyes, and causes the human eyes feel and affects watching. Thus, the frameless display device needs to add one coating process for the sides of the display panel to solve light leakage problem.

### SUMMARY

The aim of this application is to provide a display panel capable of solving light leakage problem and saving cost.

This application further provides a method for manufacturing the display panel.

The aim of this application is achieved through a technical scheme as follow: a display panel, including: a first substrate, a second substrate, and a control circuit. The second substrate opposite to the first substrate. The control circuit fixed on the first substrate or the second substrate through a common sealant; where an edge of the first substrate and an edge of the second substrate are sealed by the common sealant. The common sealant is Tuffy glue. Only edges of two sides of both sides of the first substrate and the second substrate are sealed by the common sealant. A width of the first substrate is greater than that of the second substrate, and a first side of the first substrate is aligned with a first side of the second substrate. The common sealant covers the first side of the first substrate and the first side of the second substrate simultaneously, and covers a second side of the first substrate. The control circuit is fixed on a second side of the second substrate. The control circuit includes an integrated circuit and a printed circuit board, a joint of the integrated circuit and the first substrate or the second substrate is covered with the common sealant; and a joint of the printed circuit board and the first substrate or the second substrate is covered with the common sealant.

A display panel, including: a first substrate, a second substrate, and a control circuit. The second substrate opposite to the first substrate. The control circuit fixed on the first substrate or the second substrate by a common sealant; where edges of the first substrate and the second substrate are sealed by the common sealant.

Optionally, the control circuit is fixed on the first substrate or the second substrate through the common sealant, and the edges of the first substrate and the second substrate are sealed by the common sealant, and the corresponding two gluing actions are performed in a same device.

Optionally, the common sealant is Tuffy glue.

Optionally, only edges of two sides of both sides of the first substrate and the second substrate are sealed by the common sealant.

Optionally, a width of the first substrate is greater than a width of the second substrate. A first side of the first substrate is aliened with a first side of the second substrate. The common sealant covers the first side of the first substrate and the first side of the second substrate simultaneously, and covers a second side of the first substrate. The control circuit is fixed on a second side of the second substrate.

Optionally, the control circuit includes an integrated circuit, and a joint of the integrated circuit and the first substrate is covered with the common sealant.

Optionally, the control circuit includes an integrated circuit; and a joint of the integrated circuit and the second substrate is covered with the common sealant.

Optionally, the control circuit includes an integrated circuit; and a joint of the integrated circuit and the first substrate and the second substrate are covered with the common sealant.

Optionally, the control circuit includes a printed circuit board; and a joint of the printed circuit board and the first substrate or the second substrate is covered with the common sealant.

Optionally, the control circuit includes an integrated circuit and a printed circuit board; a joint of the integrated circuit and the first substrate or the second substrate is covered with the common sealant, and a joint of the printed circuit board and the first substrate or the second substrate is covered with the common sealant.

Optionally, the common sealant used for fixing the printed circuit board on the display panel, fixing the integrated circuit on the printed circuit board, and sealing sides of frames of the display panel is a same sticking substance.

Optionally, the printed circuit board is fixed on the display panel through the common sealant, the integrated circuit is fixed on the printed circuit board through the common sealant, and the sides of the frames of the display panel are sealed by the common sealant; and the corresponding three gluing actions are performed in a same device.

Optionally, the display panel is a plane type panel or a curved surface type panel.

A method for manufacturing a display panel including steps of:

fixing a control circuit on a first substrate or a second substrate by a common sealant; and

sealing edges of the first substrate and the second substrate by the common sealant.

Optionally, before the step of fixing a control circuit on the first substrate or the second substrate by the common sealant, the method also includes:

forming a black matrix on the display panel; and

disposing a polarizer on the display panel.

Optionally, the common sealant is Tuffy glue, and the Tuffy glue is coated in a glue dispensing mode.

Optionally, an edge of the polarizer is coated with the Tuffy glue.

Optionally, the control circuit is fixed on the first substrate or the second substrate through the common sealant, and the edges of the first substrate and the second substrate are sealed by the common sealant; and the corresponding two gluing actions are performed in a same device.

Optionally, the control circuit includes an integrated circuit and a printed circuit board; the printed circuit board is fixed on the display panel through the common sealant, the integrated circuit is fixed on the printed circuit board through the common sealant, and the sides of the frames of the display panel are sealed by the common sealant; and the corresponding three gluing actions are performed in a same device.

The control circuit uses the common sealant to fix, and the edges of the two substrates use the common sealant 8 to seal. The frameless display apparatus integrates other common sealant coating process with side glue coating process for sides of the display panel, and operates two coating process in a same device, thus, the frameless display apparatus does not need to add one device to operate the side glue coating process for the sides of the display panel without adding side sealing device, further saving device cost.

### BRIEF DESCRIPTION OF DRAWINGS

The drawings included are used for providing further understanding of embodiments of the present application, constitute part of the description, and are used for illustrating implementation manners of the present application, and interpreting principles of the present application together with text description. Apparently, the drawings in the following description are merely some embodiments of the present application, and for those ordinary skilled in the art, other drawings can also be obtained according to the drawings, without contributing creative labor. In the drawings:

FIG. 1 is a structural schematic diagram of a display panel according to an embodiment of this application.

FIG. 2 is a side-view schematic diagram of the display panel according to the embodiment of this application.

FIG. 3 is a step schematic diagram ref the display panel according to the embodiment of this application.

FIG. 4 is a step schematic diagram of another display panel according to the embodiment of this application.

FIG. 5 is a step schematic diagram of another display panel according to the embodiment of this application.

### DETAILED DESCRIPTION

Specific structure and function details disclosed herein are only representative and are used for the purpose of describing exemplary embodiments of the present application. However, the present application may be specifically achieved in many alternative forms and shall not be interpreted to be only limited to the embodiments described herein.

It should be understood in the description of the present application that terms such as “central”, “horizontal”, “upper”, “lower”, “left”, “right”, “vertical”, “horizontal”, “top”, “bottom”, “inner”, “outer”, etc. indicate direction or position relationships shown based on the drawings, and are only intended to facilitate the description of the present application and the simplification of the description rather than to indicate or imply that the indicated device or element must have a specific direction or constructed and operated in a specific direction, and therefore, shall not be understood as a limitation to the present application. In addition, the terms such as “first” and “second” are only used for the purpose of description, rather than being understood to indicate or imply relative importance or hint the number of indicated technical features. Thus, the feature, limited by “first” and “second” can explicitly or impliedly include one or more features. In the description of the present application, the meaning of “a plurality of” is two or more unless otherwise specified. In addition, the term “comprise” and any variant are intended to cover non-exclusive inclusion.

It should be noted in the description of the present application that, unless otherwise specifically regulated and defined, terms such as “installation,” “bonded,” and “bonding” shall be understood in broad sense, and for example, may refer to fixed bonding or detachable bonding or integral bonding; may refer to mechanical bonding or electrical bonding; and may refer to direct bonding or indirect bonding through an intermediate medium or inner communication of two elements. For those of ordinary skill in the art, the meanings of the above terms in the present application may be understood according to concrete conditions.

The terms used herein are intended to merely describe concrete embodiments, not to limit the exemplary embodiments. Unless otherwise noted clearly in the context, singular forms “one” and “single” used herein are also intended to comprise plurals. It should also be understood that the terms “comprise” and/or “include” used herein specify the existence of stated features, integers, steps, operation, units and/or assemblies, not excluding the existence or addition of one or more other features, integers, steps, operation, units, assemblies and/or combinations of these.

The present application will be further described in detail below combination with the drawings and embodiments.

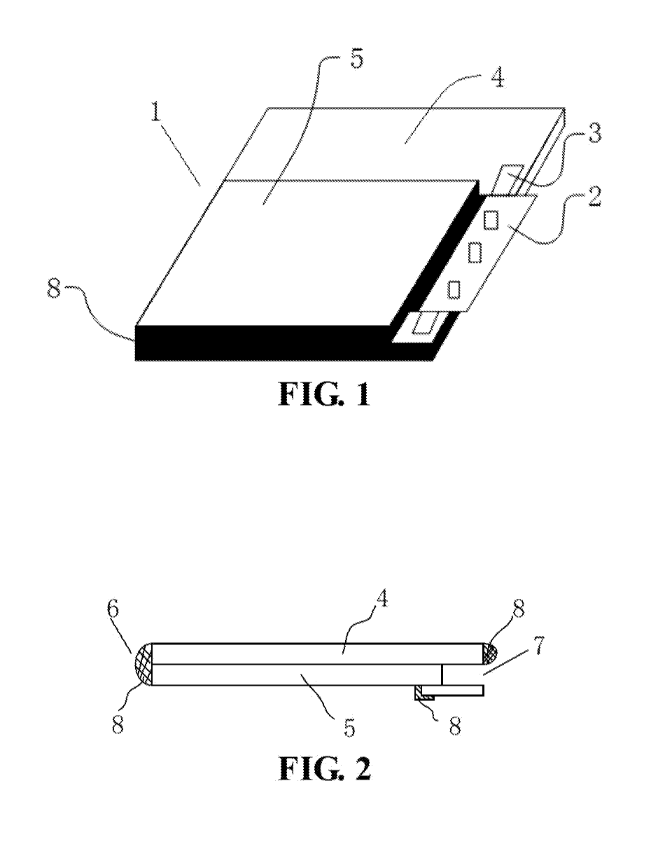

In one or more embodiments of this application, FIG. 1 and FIG. 2 are a display panel 1 of the embodiment of this application, where the display panel 1 includes a first substrate 4 and a second substrate 5 opposite to the first substrate 4. The display panel 1 further includes a control circuit 2, where the control circuit 2 is fixed on the first substrate 4 or the second substrate 5 by a common sealant 8. Edges of the first substrate 4 and the second substrate 5 by the common sealant 8. The control circuit 2 is fixed by using the common sealant 8, and the common sealant 8 is also used for side sealing on the edges of the two substrates of the display panel 1. A frameless display apparatus integrates other coating process of the common sealant 8 with side glue coating of the display panel 1 to perform two gluing operations in a same device, thus, the frameless display apparatus does not to add one device to operate the side glue coating process for the sides of the display panel without adding side sealing device, further saving device cost.

In one or more embodiments, the common sealant 8 is Tuffy glue, where the Tuffy glue is a resin colloid dedicated to the electronics industry, is a blue liquid state, and is easy to be volatile. The Tuffy glue has excellent moisture-proof sealant and good adhesion, and is to protect electronic components.

In one or more embodiments, only edges of two sides of both sides of the first substrate 4 and the second substrate 5 are sealed by the common sealant 8. As the sides is easy to be light leakage, the sides use the common sealant 8 to coat, avoiding the light leakage, reducing coating process, reducing using of the common sealant, and decreasing cost.

In one or more embodiments, the control circuit 2 includes an integrated circuit, and a joint of the integrated circuit and the first substrate 4 or the second substrate 5 is covered with the common sealant 8. It is a specific type of the control circuit 2, which is direct bond the integrated circuit on the substrate. It should be understood that the control circuit 2 includes a printed circuit board, and a joint of the printed circuit board and the first substrate or the second substrate is covered with the common sealant 8. This is an another specific tori of the control circuit 2 suitable for a solution of bonding a printed circuit board to a substrate. The Printed Circuit Board (PCB) and the display panel 1 are also connected by the common sealant 8. The Integrated Circuit (IC) and the printed circuit board are also fixed by the common sealant 8, and a frame of the display panel 1 is also subjected to side sealing by the common sealant 8. The coating of the common sealant 8 can be integrated, so that three gluing operations are performed in a same device without needing one more device for side glue coating of the display panel 1, thereby eliminating a need to purchase side sealing equipment and saying equipment costs.

In one or more embodiments of this application, FIG. 2 is a display panel 1 of the embodiment of this application, where the display panel 1 includes a first substrate 4 and a second substrate 5. A width of the first substrate 4 is greater than a width, of the second substrate 5, and a first side 6 of the first substrate 4 is aligned with a first side 6 of the second substrate 5. The common sealant 8 covers the first side 6 of the first substrate 4 and the first side 6 of the second substrate 5 simultaneously, and covers a second side 7 of the first substrate 4. And the control circuit 2 is fixed on a second side 7 of the second substrate 5. The control circuit 2 is disposed on the second substrate 5 that is shorter than the first substrate 4, thus, the common sealant is covered on the control circuit 2 and also can be covered on the second side 7 of the second substrate 5, which reduces a step for individual coating the second side 7 of the second substrate 5, and improves production efficiency.

In one or more embodiments, the common sealant 8 is Tuffy glue, where the Tuffy glue is a resin colloid dedicated to the electronics industry, is a blue liquid state, and is easy to be volatile. The Tuffy glue has excellent moisture-proof sealant and good adhesion, and is to protect electronic components.

In one or more embodiments, the control circuit 2 includes an integrated circuit, where the common sealant 8 covers a connected position of the integrated circuit and the first substrate 4 or the second substrate 5. It is a specific type of the control circuit 2, which is direct bond the integrated circuit on the substrate. It should be understood that the control circuit 2 includes a printed circuit board, where the common sealant 8 covers a connected position of the printed circuit board and the first substrate or the second substrate. It is an another specific type of the control circuit 2, which is direct bond the printed circuit board on the substrate. The printed circuit board is connected to the display panel 1 by the common sealant 8. The printed circuit board and the integrated circuit use the common sealant 8 to fix, and frames of the display panel 1 use the common sealant 8 to side seal. The coating process of the common sealant 8 can be integrated and operated in the same device, which does not to add one device to operate the side glue coating process for the sides of the display panel without adding side sealing device, further saving device cost.

It should need to notice that the display panel 1 of this application can be a plane type panel or a curved surface type panel, and be applied to a liquid crystal display or an Organic Light Emitting Diode (OLED).

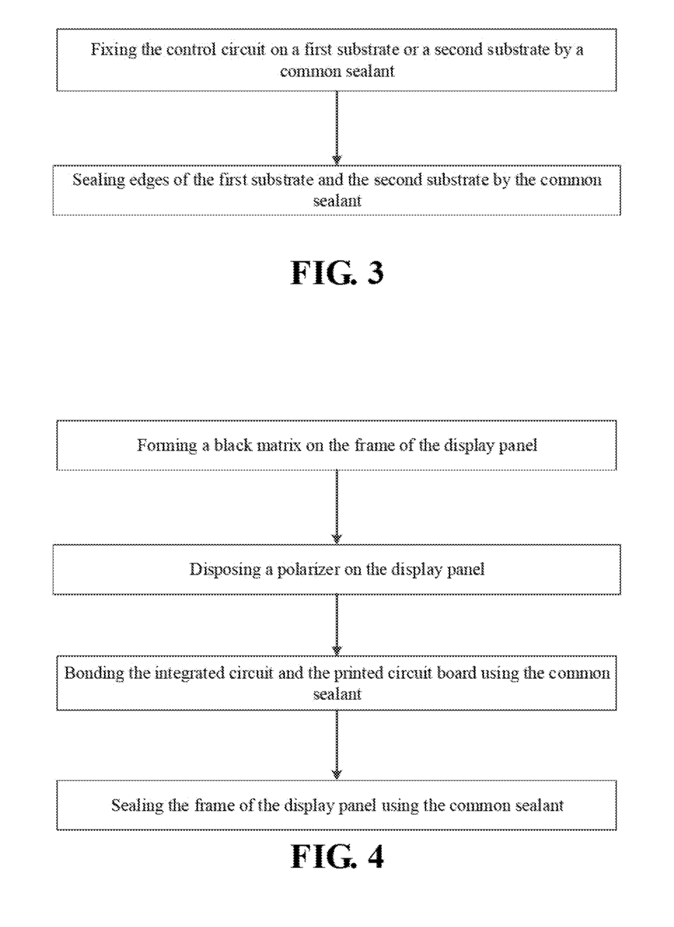

In one or more embodiments of this application, FIG. 3 is a method for manufacturing a display panel, including steps of:

fixing a control circuit 2 on a first substrate 4 or a second substrate 5 by a common sealant 8; and

sealing edges of the first substrate 4 and the second substrate 5 by the common sealant 8.

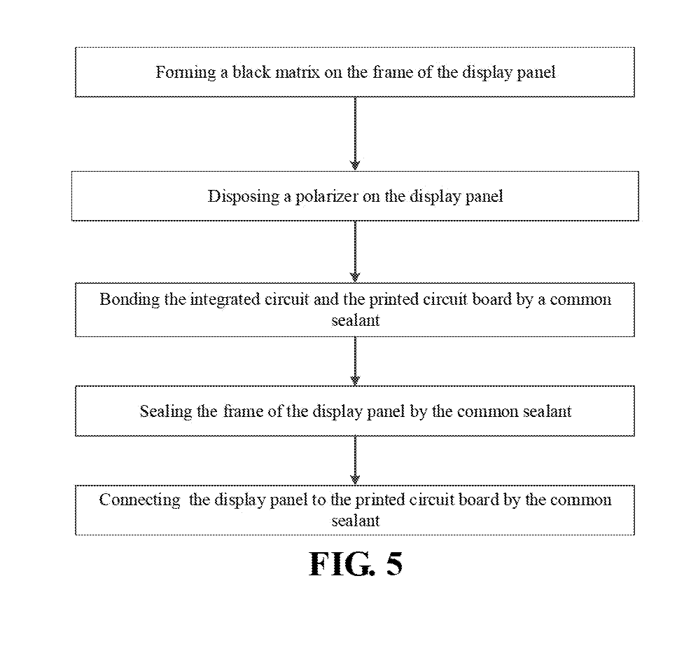

In one or more embodiments of this application, FIG. 4 and FIG. 5 is the method for manufacturing the display panel 1 according to the embodiment of this application. Before the step of fixing a control circuit on the first substrate or the second substrate by the common sealant, the method also includes following steps:

forming a black matrix, on a frame of the display panel 1;

and disposing a polarizer on the display panel 1.

The display panel includes a printed circuit board 2 and an integrated circuit. The method includes the steps: arranging the black matrix on the frame of the display panel; arranging the polarizer on the display panel 1; and fixing the printed circuit board and the integrated circuit using the common sealant 8. In this solution, the printed circuit board and an outer lead 3 are bonded by Outer Lead Bonding (OLB), and conductive particles of Anisotropic Conductive Film (ACF) are broken and deformed by pressing machine head, which causes the combination of the printed circuit board and pins of two sides of the display panel 1 and achieves circuit conduction. The frame of the display panel 1 uses the common sealant 8 to seal, and a frameless display apparatus integrates other common sealant 8 coating process with side glue coating process for sides of the display panel 1, and operates two coating process in a same device, thus, the frameless display apparatus does not need to add one device to operate the side glue coating process for the sides of the display panel 1 without adding side sealing device, further saving device cost.

In one or more embodiments, the display panel is tested when the black matrix is disposed on the frame of the display panel 1. The process of frameless display includes a coating process to execute black matrix by a coating machine, and covers peripheral line area of an array substrate, further avoiding user eyes from seeing bad display caused by reflected light. After the polarizer is disposed on the display panel 1, the display panel 1 needs to be tested and cut. The polarizer of the, display panel 1 needs to satisfy a certain accuracy requirement. After the frame of the display panel 1 use the common sealant 8 to seal and the display panel is reversed, the display panel 1 is tested. Finally, the display panel 1 is connected to the printed circuit board.

In one or more embodiments the common sealant 8 is Tuffy glue, and the Tuffy glue is coated in a glue dispensing mode. The Tuffy glue has excellent moisture-proof sealant and good insulation, further avoiding the polarizer from upwarping and avoiding moisture. The dispensing way is a process, and is also known as sizing, gumming, irrigating, and dripping and so on. The dispensing way uses electric glue, oil or other liquid to coat, irrigate and drip on the product, and the products play pasting, irrigating, insulating, fixing, and having smooth surface and so on.

In one or more embodiments, the polarizer is disposed on two surface of the display panel 1, and edge of the polarizer uses the Tuffy glue to coat. The Toffy glue has excellent moisture-proof sealant and good insulation, which avoids the polarizer from upwarping and avoids moisture.

After the frame of the display panel 1 uses the common sealant 8 to seal, the method further includes: connecting the printed circuit board to the display panel 1 using the common sealant 8. The common sealant 8 is used in different process, and cost is saved through bulk-purchase. The same device can be use when coating the common sealant 8, further reducing coating device and simplifying production line.

As the above, it should be understood that this application has been described with reference to certain and alternative embodiments which are intended to be exemplary only and do not limit the full scope of this application as set forth in the appended claims.

What is claimed is:

1. A display panel, comprising:
a first substrate;
a second substrate opposite to the first substrate; and
a control circuit, fixed on the first substrate or the second substrate through a common sealant; comprising:
an integrated circuit;
and a printed circuit board;
wherein an edge of the first substrate and do edge of the second substrate are sealed by the common sealant, and the common sealant is Tuffy glue; only edges of two sides of both sides of the first substrate and the second substrate are sealed by the common sealant; a width of the first substrate is greater than that of the second substrate, and a first side of the first substrate is aligned with a first side of the second substrate; the common sealant covers the first side of the first substrate and the first side of the second substrate simultaneously, and covers a second side of the first substrate; the control circuit is fixed on a second side of the second substrate; a joint of the integrated circuit and the first substrate or the second substrate is covered with the common sealant; and a joint of the printed circuit board and the first substrate or the second substrate is covered with the common sealant.

2. A display panel, comprising:
a first substrate;
a second substrate opposite to the first substrate; and
a control circuit fixed on the first substrate or the second substrate by a common sealant;
wherein edges of the first substrate and the second substrate are sealed by the common sealant.

3. The display panel according to claim 2, wherein the common sealant is Tuffy glue.

4. The display panel according to claim 2, wherein only edges of two sides of both sides of the first substrate and the second substrate are sealed by the common sealant.

5. (canceled)

6. The display panel according to claim 4, wherein a width of the first substrate is greater than a width of the second substrate, and a first side of the first substrate is aligned with a first side of the second substrate;
the common sealant covers the first side of the first substrate and the first side of the second substrate simultaneously, and covers a second side of the first substrate,
and the control circuit is fixed on a second side of the second substrate.

7. (canceled)

8. The display panel according to claim 2, wherein the control circuit comprises an integrated circuit; and a joint of the integrated circuit and the first substrate is covered with the common sealant.

9. The display panel according to claim 2, wherein the control circuit comprises an integrated circuit; and a joint of the integrated circuit and the second substrate is covered with the common sealant.

10. The display panel according to claim 2, wherein the control circuit comprises an integrated circuit; and a joint of the integrated circuit and the first substrate and the second substrate are covered with the common sealant.

11. The display panel according to claim 2, wherein the control circuit comprises a printed circuit board; and a joint of the printed circuit board and the first substrate or the second substrate is covered with the common sealant.

12-13. (canceled)

14. A method for manufacturing the display panel, comprising steps of:
fixing a control circuit on a first substrate or a second substrate by a common sealant; and
sealing edges of the first substrate and the second substrate by the common sealant.

15. The method for manufacturing the display panel according to claim 14, wherein before the step of fixing a control circuit on the first substrate or the second substrate by the common sealant, the method also comprises:
forming a black matrix on the display panel; and
disposing a polarizer on the display panel.

16. The method for manufacturing the display panel according to claim 14, wherein the common sealant is Tuffy glue, and the Tuffy glue is coated in a glue dispensing mode.

17. The method for manufacturing the display panel according to claim 15, wherein an edge of the polarizer is coated with the Tuffy glue.

18-20. (canceled)

21. The display panel according to claim 2, wherein the control circuit is fixed on the first substrate or the second substrate through the common sealant, and the edges of the first substrate and the second substrate are sealed by the common sealant; and the corresponding two gluing actions are performed in a same device.

22. The display panel according to claim 2, wherein the control circuit comprises an integrated circuit and a printed circuit board; a joint of the integrated circuit and the first substrate or the second substrate is covered with the common sealant, and a joint of the printed circuit board and the first substrate or the second substrate is covered with the common sealant.

23. The display panel according to claim 22, wherein the common sealant used for fixing the printed circuit board on the display panel, fixing the integrated circuit on the printed circuit board, and sealing sides of frames of the display panel is a same sticking substance.

24. The display panel according to claim 23, wherein the printed circuit board is fixed on the display panel through the common sealant, the integrated circuit is fixed on the printed circuit board through the common sealant, and the sides of the frames of the display panel are sealed by the common sealant; and the corresponding three gluing actions are performed in a same device.

25. The display panel according to claim 2, wherein the display panel is a plane type panel or a curved surface type panel.

26. The method for manufacturing the display panel according to claim 14, wherein the control circuit is fixed on the first substrate or the second substrate through the common sealant, and the edges of the first substrate and the second substrate are sealed by the common sealant; and the corresponding two gluing actions are performed in a same device.

27. The method for manufacturing the display panel according to claim 14, wherein the control circuit comprises an integrated circuit and a printed circuit board; the printed circuit board is fixed on the display panel through the common sealant, the integrated circuit is fixed on the printed circuit board through the common sealant, and the sides of the frames of the display panel are sealed by the common sealant; and the corresponding three gluing actions are performed in the same device.
